(19) United States
(12) Patent Application Publication
(10) Pub. No.: US 2009/0169724 A1
(43) Pub. Date: Jul. 2, 2009

(54) Conductive paste for use in membrane touch switch applications

(76) Inventor: Toshiaki Ogiwara, Utsunomiya-shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/005,530

(22) Filed: Dec. 27, 2007

(51) Int. Cl. H01B 1/02; H01B 1/06

(52) U.S. Cl. 427/77; 252/500; 252/514

(57) ABSTRACT

A thick film paste for membrane touch switch (MTS) uses includes: a) electrically conductive powder; b) phenoxy resin; c) urethane resin; and d) an organic solvent, in which the above a), b) and c) are dissolved or dispersed. MTS made from the paste shows excellent properties such as low resistivity and low resistivity change after creasing. In addition, the content of halogen is very low.

### FIELD OF THE INVENTION

The invention is directed to improved conductive paste useful for manufacturing membrane touch switches.

### TECHNICAL BACKGROUND

A “membrane touch switch” (MTS) is widely used for keyboard or electric switches, using its property of high flexibility and light weight. Thick film paste is typically used to make circuits and electrodes for MTS.

A thick film paste includes particles containing conductive materials dispersed in an organic vehicle or medium containing volatile solvent and a polymeric resin. After screen-printing, the composition is dried, typically by heating to dry off organic solvent. It is desirable for resulting circuits and electrodes to have good flexibility so that properties of circuits and electrodes can be maintained even after a numerous numbers of touches.

The conductive material is responsible for imparting to the thick film material the desired level of resistivity. The conductive particles typically consist of silver metal for high conductivity and good resistance to oxidation and can be found in flake or non-flake morphologies.

The polymeric resin's primary function is to bind together the conductive particles to form an electrically conductive circuit pattern. Additionally, the binder system is required to impart the necessary adhesion to the desired substrate.

Halogen-containing resin has been used for resinous components in conductive pastes for MTS. U.S. Pat. No. 5,653,918, for example, discloses a highly flexible and mechanically robust screen-printable conductive composition containing (a) a conductive phase comprising Ag, Au, Cu, Ni, Pd, Pt, C or graphite and mixtures thereof dispersed in a polymer solution containing (b) a terpolymer of polyvinyl acetate, vinyl chloride and a polar component dissolved in a volatile solvent. U.S. Pat. No. 6,939,484 discloses a thick film conductive composition containing (a) electrically conductive silver powder; (b) PVDF/HFP polymer resin, copolymers of a PVDF/HFP polymer resin, and mixtures thereof; dissolved in c) organic solvent.

However, with increased attention to environmental issues, low halogen-containing, preferably halogen-free, material is desired. JP2005-197226A discloses, for the purpose of uniformity of coated film and flexibility of film, an electroconductive paste containing a conductive powder and a polyester resin having an acid value of 0.3 to 2.2 mgKOH/g. However, a conductive paste described in JP2005-197226 gives even higher resistivity. According to the experimental data in JP2005-197226, resistivity is 4.2 to 5.3×10⁻⁵ Ω□cm.

Thick film pastes are needed that have excellent properties for MTS and also have low halogen content for environmental desirability.

### SUMMARY OF THE INVENTION

One aspect of the present invention is a thick film paste for membrane touch switch comprising: a) electrically conductive powder; b) phenoxy resin; c) urethane resin; and d) an organic solvent, in which the above a), b) and c) are dissolved or dispersed.

Another aspect of the present invention is a method for producing a circuit and/or electrode of a membrane touch switch, comprising the steps of: applying a thick film paste comprising a) electrically conductive powder; b) phenoxy resin; c) urethane resin; and d) an organic solvent, in which the above a), b) and c) are dissolved or dispersed, on a substrate of a membrane touch switch; and drying the applied thick film paste to vaporize the organic solvent.

The membrane touch switches made from the pastes of the present invention show excellent properties such as low resistivity and low resistivity change after creasing. In addition, the content of halogen is very low in the pastes of the present invention.

### DETAILED DESCRIPTION OF THE INVENTION

One aspect of the present invention is a thick film paste for membrane touch switch. The thick film paste includes a) electrically conductive powder; b) phenoxy resin; c) urethane resin; and d) an organic solvent, in which the above a), b) and c) are dissolved or dispersed. Optionally, additional components are included in the paste. The paste includes both phenoxy resin and urethane resin instead of conventional halogen-containing resin shows excellent properties. Further, specific conductive powder shows excellent properties as described hereinafter. The components of the paste are discussed herein below.

A) Components of Paste

a) Electrically Conductive Powder

The electrically conductive powder gives conductivity to a formed circuit or electrode. The conductive powder includes, but is not limited to, Ag, Au, Pt, Pd, Cu, Ru, Ni, Al, conductive carbon. Alloy such as Ag—Pd can be used as conductive powder. Inorganic particles, coated with conductive metal or alloy, can also be used. Mixtures of one or more conductive powders can be used. Preferably, silver powder is used in terms of conductivity, anti-oxidation property and material cost.

The shape of conductive powder is preferably flaky rather than spherical or needle-shaped. It was found that the flaky powder can provide low resistivity and good viscosity. The term “Flaky” herein includes rod-shaped, cone-shaped and plate-shaped. In terms of rheology modification, fluffy powder is also preferably used.

The average particle size of the conductive powder is, not limited to, but preferably in the range of 0.5 to 5 micrometer, more preferably in the range of 1 to 3 micrometer. The average particle size can be measured by use of particle analyzer provided by Horiba or Microtrac, or direct particle size measurement by SEM. In case fluffy powder is used as conductive powder, the tap density of the fluffy powder is preferably in the range of 0.1 to 1.0 g/ml, more preferably in the range of 0.1 to 0.5 g/ml.

In case both flaky and fluffy powder is used, the ratio of flaky powder to fluffy powder is preferably 90:10 to 60:40, more preferably 90:10 to 70:30 in terms of better viscosity and resistivity.

The ratio of “the conductive powder to organic binder”, which is described below, is preferably 95:5 to 85:15. When the conductive powder is more than 95%, the dried paste film tends to become brittle. When the conductive powder is less than 85%, the resistivity of the dried paste tends to increase.

b) Phenoxy Resin

Phenoxy resin is included as organic binder in the conductive paste. Phenoxy resin is a polymer obtained by the polymerization of bisphenol A and epichlorohydrin, which has usually more than 30,000 of weight, averaged molecular weight. The preferable weight averaged molecular weight of the phenoxy resin applied for this invention is more than 50,000. When the weight averaged molecular weight of the phenoxy resin is less than 50,000, the obtained paste viscosity tends to be low in terms of printing. The upper limit of the weight averaged molecular weight is not limited, but practically, the upper limit is 100,000.

The examples of the phenoxy resin applied in this invention are PKHH™, PKHC™ and PKFE™ provided by Inchem.

c) Urethane Resin

Urethane resin is included as organic binder in the conductive paste. Urethane resin is obtained by the polymerization of a compound which has two or more hydroxyl groups and a compound which has two or more isocyanate groups. A compound which has two or more carboxyl groups can be also partially added.

The examples of compounds which have two or more hydroxyl groups are, 1,4-butanediol, 1,6-hexanediol, ethylene glycol, propylene glycol, poly glycol ethers, a compounds which is obtained by the polymerization of olefin oxide, such as ethylene oxide or propylene oxide.

The examples of compounds which have two or more isocyanate groups are tolirenediisocyanate (TDI), xylirenediisocyanate (XDI), diphenylmethanediisocyanate (MDI). The examples of compounds which have two or more carboxyl groups are adipic acid, oxalic acid, malonic acid, succinic acid.

The examples of the urethane resin applied in this invention are Desmocol™ 350 and Desmocol™540 provided by Bayer Material Science.

The weight ratio of the phenoxy resin/the urethane resin has impact on the properties of resulting circuit and electrode. The weight ratio of the phenoxy resin/the urethane resin is preferably 30:70 to 70:30 by weight, more preferably 40:60 to 60:40 by weight. By adjusting the weight ratio, the dried conductive paste has good crease property with hardness. If the phenoxy ratio is more than 70, the dried paste tends to loose the flexibility. If the phenoxy resin ratio is less than 30, the hardness and the resistivity of the dried paste tend to be inefficient.

d) Organic Solvent

The electrically conductive powder, the phenoxy resin, the urethane resin, and optional additional components is dissolved or dispersed in organic solvent.

The organic solvent includes, but are not limited to, ethylene glycol monomethy ether, propylene glycol monomethyl ether acetate, methyl propasol acetate, 1-methoxy-2 propanol acetate, methyl cellosolve acetate, butyl propionate, primary amyl acetate, hexyl acetate, cellosolve acetate, pentyl propionate, diethylene oxalate, dimethyl succinate, dimethyl glutarate, dimethyl adipate, methyl isoamyl ketone, methyl n-amyl ketone, cyclohexanone, diacetone alcohol, diisobutyl ketone, n-methyl pyrolidone, butyrolactone, isophorone, methyl n-isopropyl ketone, ethyl acetate, terpenes such as alpha- or beta-terpineol, kerosene, dibutylphthalate, butyl carbitol, butyl carbitol acetate, hexylene glycol, butyrolactone etc. Mixture of one or more organic solvents can be used to obtain the desired viscosity and volatility requirements. Volatile liquids for promoting rapid hardening after application on the substrate can be included in the paste.

The content of the organic solvent is generally 30 to 60 wt %, preferably 40 to 50 wt % based on the total weight of the conductive paste.

The main purpose of the organic vehicle (organic binder and solvent) is to disperse finely divided particles of the composition in such form that it can readily be applied to a flexible or other substrate. Thus, the organic vehicle is required first of all to be one in which the particles are dispersible with an adequate degree of stability. Secondly, the rheological properties of the organic vehicle are required to be such that they lend good application properties to the dispersion.

e) Additional Components

The paste can contain additional components to enhance property of the paste. The additives are, for example, silane, coupling agent, thixotropic modifiers. There also can use some hardeners such as blocked isocyanate reacted with polyurethane, phenol resin reacted with phenoxy resin and other curing agents.

Furthermore, it is known that small amounts of metals may be added to the conductive paste to improve the properties of the paste. Some examples of such metals include: molybdenum, tungsten, tantalum, tin, indium, lanthanum, gadolinium, boron, cobalt, titanium, yttrium, europium, gallium, sulfur, zinc, silicon, magnesium, barium, cerium, strontium, lead, antimony and combinations thereof and others common in the art of thick film compositions.

B) Preparation of Paste

The components of the present paste are generally mixed by mechanical mixing using a planetary mixer, then dispersed on a three roll mill to form a paste having suitable consistency and rheology for printing.

Most thick film pastes are applied to a substrate by means of screen printing. Therefore, they are desired to have appropriate viscosity so they can be passed through the screen readily. In addition, they are desired to be thixoptropic in order that they set up rapidly after being screen printed, thereby giving good resolution. For thick film compositions suitable for high speed printing, the relaxation rate constant (kᵣ) for the paste is 0.01-0.1 and preferably 0.025-0.05.

C) Application of Paste

Another aspect of the present invention relates to a method for producing a circuit and/or electrodes of MTS. The method can be applied to form either one of circuit and electrodes. Of course, both of circuit and electrodes can be formed by using the conductive paste of the present invention. Additionally, the present invention relates to a membrane touch switch utilizing the composition described herein and above and a membrane touch switch formed by the method described herein.

Various substrates can be used as a substrate onto which the paste is applied. The substrate includes, but not limited to, PET, PEN, polyimide film.

The circuit and/or electrodes of MTS can be made by the following process. Firstly, the paste is applied on a substrate of MTS, on which circuit and/or electrodes are formed. Screen printing is generally used for the application.

Then, the printed pattern is dried to form a circuit and/or electrodes. Drying condition is, but not limited to, 80 to 160 degrees Celsius for 10 to 60 minutes.

### EXAMPLES

This invention will now be described in further detail with practical and comparative examples.

### Example 1

20 g of PKFE™ phenoxy resin supplied by Inchem was dissolved in 80 g of DBE (DiBasic Ester)-9™ solvent supplied by Invista, resulting in resin solution (1). 20 g of Desmocol™ 350 polyurethane resin supplied by Bayer was dissolved in 80 g of the mixture of DBE-9 and cylcohexanone, resulting in resin solution (2).

40 g of flaky silver powder with 1.7 um of average particle size, 10 g of fluffy silver powder with 0.3 g/ml of tap density, 13.9 g of resin solution (1), 13.9 g of resin solution (2), and 22.2 g of DBE-9 solvent were mixed well by roll milling, resulting in a conductive paste having 15 Pa-s viscosity.

A circuit line was drawn on PET film by using the resulting conductive paste. The PET film with the paste thereon was cured at 140□ for 60 min. The paste resistivity after cure was 2.8×10⁻⁵ Ω□cm and resistivity change after 10 times bending was +64%. The calculated chlorine content of this paste was 28 ppm.

### Example 2

30 g of PKHH™ phenoxy resin supplied by Inchem was dissolved in 70 g of carbitol acetate, resulting in resin solution (3). 20 g of Desmocol 530 polyurethane resin supplied by Bayer was dissolved in 80 g of the mixture of n-methyl pyrolidone and DBE-9 solvent, resulting in resin solution (4).

60 g of flaky silver powder with 4.4 um of average particle size, 11.1 g of resin solution (3), 16.7 g of resin solution (4), 6.1 g of n-methyl pyrolidone and 6.1 g of DBE-9 solvent were mixed well by roll milling, resulting in a conductive paste having 13 Pa-s viscosity.

A circuit line was drawn on PET film by using the resulting conductive paste. The PET film with the paste thereon was cured at 140□ for 60 min. The paste resistivity after cure was 2.1×10⁻⁵ Ω□cm and resistivity change after 10 times bending was +86%. The calculated chlorine content of this paste was 33 ppm.

### Comparative Example 1

25 g of UCAR™ VGAF vinyl chloride copolymer resin supplied by Dow Chemical was dissolved in the mixture of γ-butyrolactone and propyleneglycol methylether acetate, resulting in resin solution (5). 20 g of Desmocol 530 polyurethane resin was dissolved in 80 g of DBE-9 solvent, resulting in solution (6).

50 g of flaky powder with 2.9 um of average particle size, 0.8 g of carbon black with ca.40 nm first particle size, 18.5 g of resin solution (5), 10.0 g of resin solution (6), 20.2 g of DBE-9 solvent, and 0.5 g of HDI type isocyanate was mixed well by roll milling, resulting in a conductive paste having 21 Pa-s.

A circuit line was drawn on PET film by using the resulting conductive paste. The PET film with the paste thereon was cured at 140□ for 60 min. The paste resistivity after cure was 1.5×10⁻⁵ Ω□cm and resistivity change after 10 times bending was +63%. The calculated chlorine content of this paste was 11,300 ppm.

TABLE 1

| | Ex. 1 | Ex. 2 | Comp. Ex. 1 |
|---|---|---|---|
| Conductive | flaky Ag | flaky Ag | flaky Ag |
| Powder | fluffy Ag | | |
| Resin | phenoxy resin | phenoxy resin | vinyl chloride |
| | polyurethane | polyurethane | polyurethane |
| Resistivity | 2.8 × 10⁻⁵ | 2.1 × 10⁻⁵ | 1.5 × 10⁻⁵ |
| (Ω□cm) | | | |
| Resistivity | +64% | +86% | +63% |
| change after | | | |
| bending | | | |
| Chlorine | 28 ppm | 33 ppm | 11,300 ppm |
| content | | | |

As shown in Table 1, the paste of the present invention (Example 1 and Example 2) shows excellent properties in terms of both resistivity and resistivity change after bending, which are equivalent to the conventional paste (Comparative Example 1). In addition, the content of halogen is quite low.

What is claimed is:

1. A thick film paste for membrane touch switch comprising:
a) electrically conductive powder;
b) phenoxy resin;
c) urethane resin; and
d) an organic solvent, in which the above a), b) and c) are dissolved or dispersed

2. A thick film paste for membrane touch switch according to claim 1, wherein the electrically conductive powder is flaky silver powder

3. A thick film paste for membrane touch switch according to claim 2, wherein the average particle size of the flaky silver powder is 0.5 to 5 micrometer

4. A thick film paste for membrane touch switch according to claim 1, wherein the electrically conductive powder is fluffy silver powder

5. A thick film paste for membrane touch switch according to claim 4, wherein the tap density of the fluffy silver powder is 0.1-1.0 g/ml

6. A thick film paste for membrane touch switch according to claim 1, wherein the molecular weight of the phenoxy resin is more than 50,000

7. A thick film paste for membrane touch switch according to claim 1, wherein the weight ratio of the phenoxy resin to the urethane resin is 30:70 to 70:30 by weight

8. A thick film paste for membrane touch switch according to claim 1, wherein the content of halogen atoms is less than 900 ppm based on the total weight of the thick film paste

9. A method for producing a circuit and/or electrode of membrane touch switch, comprising the steps of:
applying a thick film paste comprising a) electrically conductive powder; b) phenoxy resin; c) urethane resin; and d) an organic solvent, in which the above a), b) and c) are dissolved or dispersed on a substrate of membrane touch switch; and drying the applied thick film paste to vaporize the organic solvent
